(19) United States
(12) Patent Application Publication
(10) Pub. No.: US 2003/0015975 A1
(43) Pub. Date: Jan. 23, 2003

(54) Device for correcting geometrical faults of a cathode ray tube

(76) Inventor: Marc Duranton, Suresnes (FR)

Correspondence Address: Michael E. Marion, c/o U.S. PHILIPS CORPORATION, Intellectual Property Department, 580 White Plains Road, Tarrytown, NY, 10591, US

(21) Appl. No.: 10/191,412

(22) Filed: Jul. 9, 2002

(30) Foreign Application Priority Data
Jul. 17, 2001 (FR) 0109551

(51) Int. Cl. G09G 1/04

(52) U.S. Cl. 315/370; 315/406

(57) ABSTRACT

The invention relates to the field of digital television. It particularly relates to a device 11 for correcting geometrical faults of a cathode ray tube 10. This device comprises means 111 for adjusting spatial digital factors, these spatial digital factors controlling a digital circuit 112 for spatially processing images displayed on the screen 10. These adjusting means are controlled by control signals 16 which may be generated by a user by means of a remote control unit 12 and a control interface 113. The correction may also be automatic when the faults are due to certain characteristics of the image to be displayed, such as brilliance. In this case, measuring means 110 evaluate the brilliance of the image and generate a control signal 17 as a function of this brilliance.

The invention relates to a device for correcting geometrical faults of a cathode ray tube intended to display at least one output image. It also relates to a set top box for television. It finally relates to a television receiver comprising at least a cathode ray tube intended to display at least one output image.

The invention finds an application, for example, in terrestrial digital television.

U.S. Pat. No. 5,258,693 published on Nov. 2, 1993 describes a device for correcting geometrical faults of a cathode ray tube. A cathode ray tube conventionally comprises a screen and a deflection device for deflecting an electron beam, said electron beam representing a pixel on the screen of the cathode ray tube. Such a deflection device comprises coils for deflecting said electron beam horizontally or vertically. In such a cathode ray tube, geometrical faults occur which are due, for example, to poor alignment of the coils, non-uniformity of magnetic fields created by said coils or faults of the surface of the screen of the cathode ray tube, as well as by influence of external magnetic fields. In the above-mentioned patent, such geometrical faults are corrected by means of an auxiliary deflection device particularly comprising impedances and adjustable resistances.

It is an object of the invention to reduce the bulkiness of a cathode ray tube by refraining from an auxiliary deflection device for correcting geometrical faults of the cathode ray tube.

The invention takes the following consideration into account. For several years digital television systems have been in use. These digital television systems allow television programs comprising images to be broadcast, for example, by satellite, cable or via channels. A considerable number of these digital television systems propose different image formats, for example, a format of standard definition and a high definition format. For example, an American terrestrial digital television standard ATSC and a Japanese satellite television standard “BS Digital” propose 18 different image formats. The programs that are broadcast are received by a television set top box and displayed on a screen of a cathode ray tube. However, the images may be broadcast in a high definition format and displayed on a screen of the standard definition, or inversely. To realize this, the television set top box comprises a digital spatial processing circuit for spatially processing an input signal representing an input image, said circuit being controlled by spatial digital factors. This digital spatial processing circuit is particularly responsible for converting one image format to another by, for example, dimensioning or placing images intended to be displayed on the screen. Such a digital spatial processing circuit uses polyphase filters so as to determine pixel values of an image in a given format from pixel values of the image in a different format.

The invention benefits from such digital spatial processing circuits in that it allows the correction of geometrical faults of a cathode ray tube. To realize this, a correction device according to the invention and as defined in the opening paragraph is characterized in that it comprises a digital spatial processing circuit suitable for converting an input signal representing an input image in a first format into an output signal representing the output image in a second format by means of predetermined spatial digital factors, and means for adjusting said spatial digital factors, said adjusting means being controlled by control signals. These adjusting means allow correction of geometrical faults of a cathode ray tube by varying certain spatial digital factors controlling the digital circuit which is responsible for the conversion of the image formats. This digital circuit thus allows the correction of geometrical faults of the cathode ray tube. The auxiliary deflection device will thus become useless. Consequently, the bulkiness of the cathode ray tube is reduced.

In a first particularly advantageous embodiment of the invention, a correction device as described above is characterized in that said control signals are generated by a user by means of a control interface. In accordance with this embodiment, a user may himself correct geometrical faults by varying spatial digital factors. Such a variation is effected, for example, by means of a remote control unit tuned to a reception frequency of said adjusting means.

In a second, particularly advantageous embodiment of the invention, a correction device as described above is characterized in that said control signals are a function of characteristics of the image to be displayed. In accordance with this embodiment, the geometrical faults of the cathode ray tube are corrected automatically. Indeed, certain geometrical faults are due to particular characteristics of the images displayed, for example, a relatively considerable brilliance. An extent of brilliance is effected by a measuring circuit which supplies a control signal as a function of the measured brilliance.

Such a correction device may form part of a television set top box which is physically separated from an enclosure containing the cathode ray tube. In such a case, the user can control the adjusting means by way of a remote control unit or by way of an interface on the television set top box, said interface being, for example, formed as a keyboard.

Such a correction device may also form part of the enclosure containing the cathode ray tube and a television set top box, such an enclosure being commonly denoted by the term “digital television receiver”. In such a case, geometrical faults of the cathode ray tube may be corrected during manufacture of such an enclosure. Digital factors corresponding to such a correction are then stored in a non-volatile memory so as to be used during display of the images.

These and other aspects of the invention are apparent from and will be elucidated, by way of non-limitative example, with reference to the embodiment(s) described hereinafter.

In the drawings:

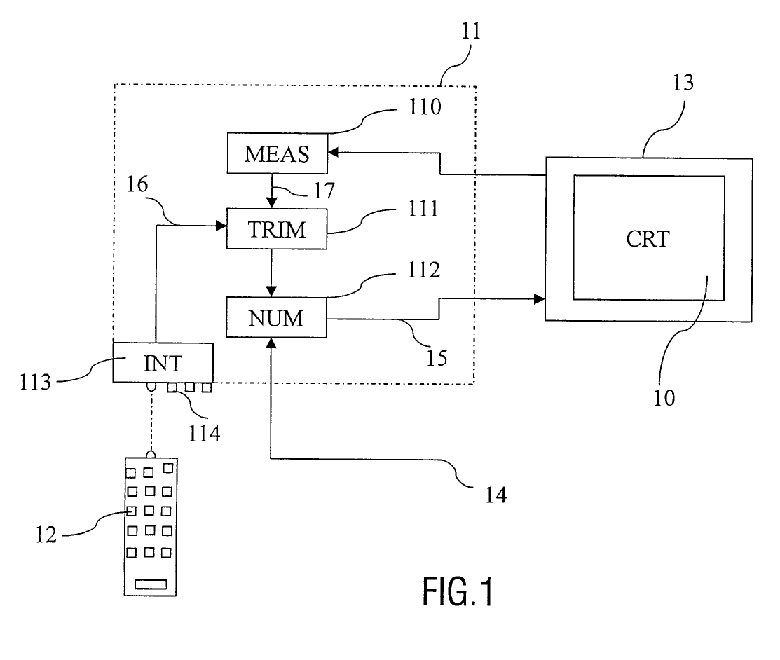

FIG. 1 is a block diagram illustrating characteristic features of a correction device according to the invention,

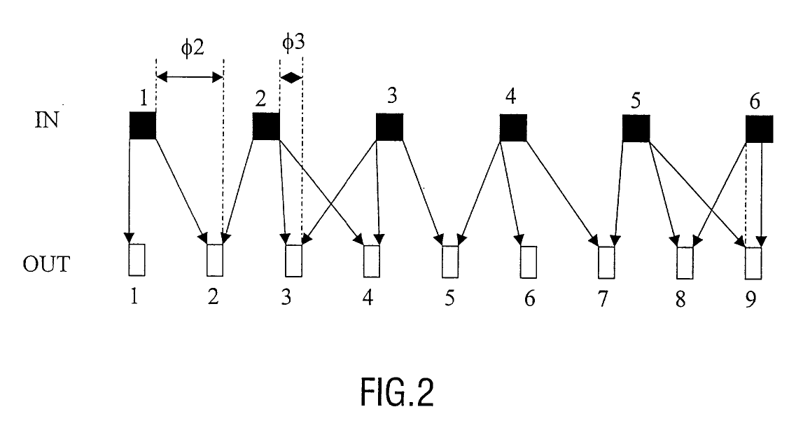

FIG. 2 illustrates a format conversion performed by a digital circuit forming part of the correction device of FIG. 1,

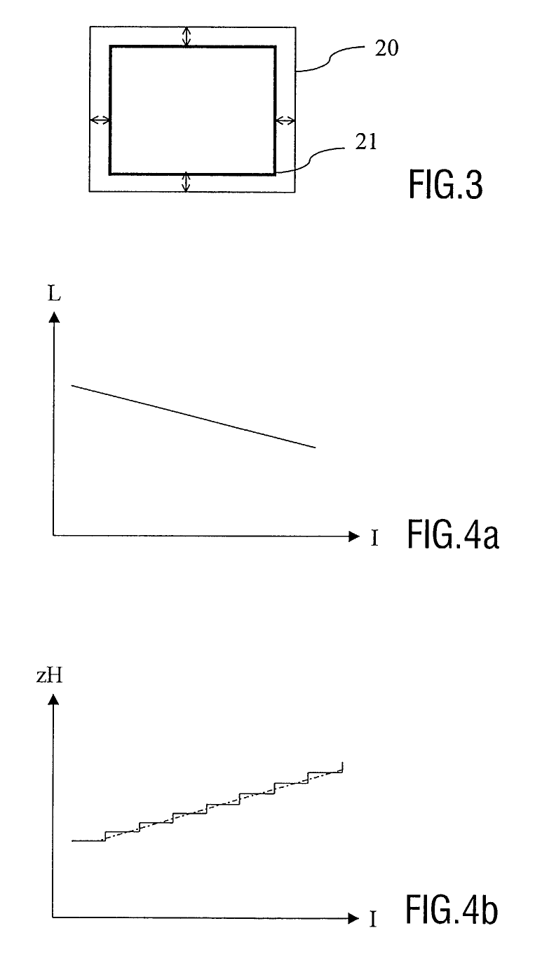

FIG. 3 illustrates a correction of an image size fault by the correction device of FIG. 1,

FIGS. 4a and 4b illustrate a calibration of a zoom factor as a function of a characteristic feature of an image, intended for automatic correction by the correction device of FIG. 1,

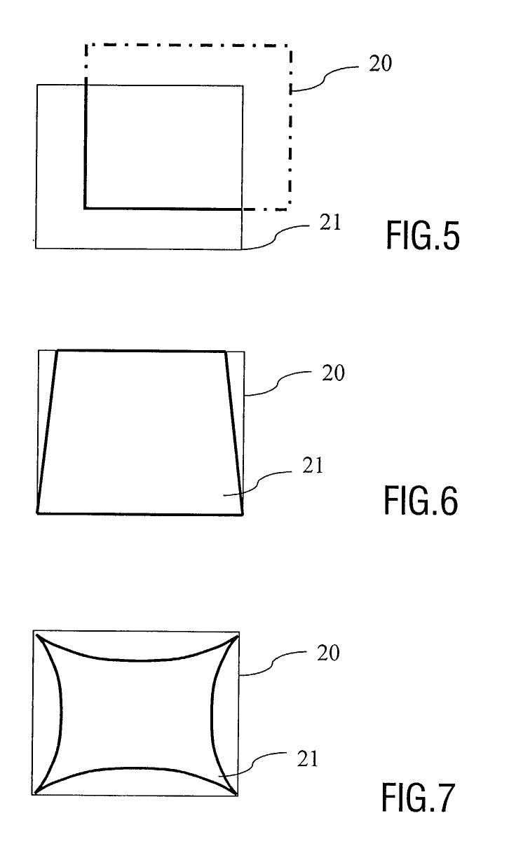

FIG. 5 illustrates a correction of an image centering fault by the correction device of FIG. 1,

FIG. 6 illustrates a correction of a trapezium distortion by the correction device of FIG. 1,

FIG. 7 illustrates a correction of a pin-cushion distortion by the correction device of FIG. 1.

FIG. 1 shows a correction device according to the invention. Such a correction device 11 comprises measuring means 110, adjusting means 111, a digital circuit 112 and a control interface 113. The correction device 11 is connected to a cathode ray tube 10 and is controlled by a remote control unit 12. The cathode ray tube 10 is contained in an enclosure 13.

The digital circuit 112 particularly allows conversion of an input signal 14 representing an input image of a first format into an output signal 15 representing an output image of a second format. By means of the remote control unit 12 and the control interface 113, a user generates a first control signal 16 which is transmitted to the adjusting means 111. It should be noted that the user may also generate the first control signal 16 from the control interface 113 comprising control keys 114. It should also be noted that the remote control unit 12 may be tuned to a tuning frequency of the adjusting means 111, in which case the control interface 113 forms part of the adjusting means 111. As a function of the first control signal 16, the adjusting means 111 vary spatial digital factors controlling the digital circuit 112, with the effect that the output signal 15 is modified for the purpose of correcting faults of the cathode ray tube 10. Such a correction will be described in detail with reference to the following Figures. The measuring means 110 may also generate a second control signal 17 for controlling the adjusting means 111. In such a case, the second control signal 17 is a function of characteristics of an image displayed by the cathode ray tube 10, for example, the brilliance.

It should be noted that the correction device 11 may form part of a television set top box connected to the enclosure 13, or may form part of the enclosure 13.

In the following description, the digital circuit 112 considered is a circuit marketed by the applicant under the name of HDVO; this is a high definition video co-processor of a digital processor marketed under the name of Nexperia PNX2700. The invention is of course also applicable to other circuits, in so far as these circuits are responsible for converting one image format into another format.

FIG. 2 illustrates a format conversion performed by the digital circuit 112. In a digital circuit such as circuit 112, the format conversion comprises a step of dimensioning as well as a step of placing images. A horizontal zoom factor zH and a vertical zoom factor zV control the dimensioning of the image. For example, an image of a standard definition comprising 480 rows of 640 pixels may be displayed on a screen of a higher definition comprising 768 rows of 1024 pixels. For converting a row of 640 pixels into a row of 1024 pixels, the horizontal zoom factor zH is set at 1024/640=8/5. The image obtained after conversion is referred to as output image and the image before conversion is referred to as input image. In a given row, the N^{th} pixel of the output image is denoted by OUT(N) and the Nth pixel of the input image is denoted IN(N). In FIG. 2a, six input pixels IN(1) to IN(6) are shown, as well as nine output pixels OUT(1) to OUT(9). In a given row, the pixel OUT(1) is situated at the same position as the pixel IN(1). The position of the pixel OUT(2) with respect to the pixel IN(1), also referred to as phase of the pixel OUT(2), is determined by the horizontal zoom factor zH. Indeed, the phase Φ2 of the pixel OUT(2) is equal to 1/zH, i.e. the distance between OUT(2) and IN(1) is equal to the distance between IN(1) and IN(2), divided by zH. For obtaining the phase and the position of the pixel OUT(N), (N−1)*(1/zH) are computed in a general manner. The result obtained is composed of an integral part E and a decimal part D. The integral part E indicates that the pixel OUT(N) is situated between the pixel IN(E+1) and IN(E+2) and the decimal part D is equal to the phase of the pixel OUT(N).

A value, valOUT(N) of the pixel OUT(N), for example, a luminance value is computed by means of the following expression:

valOUT(N)=A*valIN(E+1)+B*valIN(E+2),

where the coefficients A and B depend on the phase of the pixel OUT(N). For each phase, there is a set of different coefficients A and B; these coefficients are determined during an elaboration of the digital circuit 112 and are stored in a table in a memory. This table gives the correspondence between a phase and a set of coefficients. In the example of FIG. 2, which corresponds to a conversion of rows of 640 pixels into rows of 1024 pixels, the horizontal zoom factor has a value of 8/5 which means that there are eight different phases for the 1024 pixels of the output image. Consequently, eight sets of coefficients allow calculation of the values of the pixels of the output image.

FIG. 3 illustrates a correction of an image size fault. An image 21 displayed on a screen 20 of the cathode ray tube 10 does not occupy the whole screen 20 because of geometrical faults of the cathode ray tube 10. The zoom factors are stored in a memory of the digital circuit 112 in the form of words of 16 bits, 12 of which correspond to a fractional decimal part of the zoom factor. A precision value for a zoom factor is thus 1/4096. On a screen comprising rows of 1920 pixels, i.e. a high definition screen, this precision of the horizontal zoom factor thus corresponds to a precision of about half a pixel. Consequently, by varying the zoom factors, it is possible to control the size of the image 21 to within one pixel. The control signal generated by a user allows incrementation or decrementation of the zoom factors. In practice, one of the keys of the remote control unit 12 or of the control interface 113 allows improvement of the height of the image 21. A touch on this key generates a control signal with the effect that the vertical zoom factor zV of, for example, 1/4096 is incremented. This vertical zoom factor zV is stored in a register of the digital circuit 112, as well as the increment related to the control signal. When the digital circuit 112 receives the control signal, an adder adds the vertical zoom zV to this increment. A result of this addition is then stored in the register of the digital circuit 112, which applies this new vertical zoom factor zV to the image displayed on the cathode ray tube 10. The user touches this key several times until the size of the image 21 corresponds to the size of the screen 20. There is also a key with which the height of the image 21 can be reduced, as well as keys for increasing or decreasing the width of the image 21. In this example, the adjusting means 111 correspond to a set of circuits allowing, on the basis of the control signal, a modification of the vertical zoom factor zV. The adjusting means 111 particularly comprise an adder, a subtracter and means for writing a result in a register of the digital circuit 112.

When, for example, the horizontal zoom factor zH is modified, the pixel values must be recomputed. Let it be assumed that the horizontal zoom factor zH is increased in such a way that an image constituted by rows of 640 pixels becomes an image constituted by rows of 641 pixels. In such a case, there are 641 different phases, which necessitates storage of 640 sets of coefficients, involving a relatively considerable bulkiness of the memory of the digital circuit 112. In practice, a polyphase filter has an internal memory limited to, for example, 64 phases with which 64 sets of coefficients are associated. Such a number of phases is sufficient because the human eye is not sensitive to variations of less than one sixty-fourth of a pixel. The phase of a pixel OUT(N) as indicated above is computed and, for the computation of the value of OUT(N), the set of coefficients corresponding to the phase which is nearest to the computed phase is used.

The zoom factors may also be used for automatic correction of faults related to characteristics of the image 21, for example, brilliance. Indeed, when an image has a relatively considerable brilliance, the size of this image may diminish. Measuring the current penetrating an electron gun of the cathode ray tube allows evaluation of this brilliance. As a function of this measurement, a control signal is generated for varying the zoom factors. These zoom factors may be defined during calibration of the size of the image 21 as a function of the brilliance and then stored in a non-volatile memory. FIGS. 4a and 4b illustrate such a calibration. During an elaboration of the cathode ray tube 10, the width of the image 21 is measured for a given current intensity in the electron gun. This measurement is repeated for a certain number of current intensities. The curve of FIG. 4a is thus obtained, in which the width of the image 21 is plotted on the ordinate as a function of the current intensity plotted on the abscissa. Knowing a width of the screen 20 and the width of the image 21, the width of the screen 20 is divided by the width of the image 21 so as to obtain the horizontal zoom factor zH to be applied for a given current intensity. The broken-line curve in FIG. 4b is thus obtained, whose ordinate shows the zoom factor zH to be applied as a function of the current intensity plotted on the abscissa. As the horizontal zoom factor zH cannot be varied in a continuous manner, this broken-line curve is approached by a scaling function represented in solid lines in FIG. 4b. This function is subsequently stored in a non-volatile memory of the measuring means 110. For each brilliance measurement, a control signal is thus generated so as to adjust the horizontal zoom factor zH at the value defined by the function of FIG. 4b. Such a calibration is effected in the same way for the vertical zoom factor zV.

FIG. 5 illustrates a correction of a centering fault of the image. The image 21 is out of center with respect to the screen 20, such that a part of the image 21 is not displayed on the screen 20. In the digital circuit 112, digital spatial positioning factors control the positioning of the image 21. In the case of the HDVO circuit, these factors are, inter alia:

START_LINE_ACTIVE_VIDEO: ensures the positioning of the first row of an image displayed on the screen 20.

END_LINE_ACTIVE_VIDEO: ensures the positioning of the last row of an image displayed on the screen 20.

START_LINE_FIELD: ensures the positioning of a first column of pixels of an image displayed on the screen 20.

Similarly as it is possible to vary the zoom factors by the adjusting means 111, it is possible to vary the digital positioning factors so as to center the image 21 with respect to the screen 20. In practice, one of the keys of the remote control unit 12 or of the control interface 113 allows vertical shifting of the image 21. Pressing this key generates a control signal with the effect that the START_LINE_ACTIVE_VIDEO of, for example, 1 pixel is modified. There is also a key allowing horizontal shifting of the image 21.

In certain television formats (“letterbox”), horizontal black bands are added on both sides of the image 21. Due to geometrical faults of the cathode ray tube, these black bands may not be symmetrical. By varying the digital factors START_LINE_ACTIVE_VIDEO and END_LINE_ACTIVE_VIDEO, it is possible to adjust the symmetry of these black bands.

FIG. 6 illustrates a correction of a trapezium distortion. The image 21 has the shape of a trapezium which is due to poor symmetry of the coils for the horizontal deflection. Variable zoom factors are used in the digital circuit 112, for example, for converting an image of a format 16/9 into a format 4/3 without loss of too much information. A horizontal and a vertical zoom factor are associated with each pixel of the image and the zoom factors may differ from pixel to pixel. For converting an image of a format 16/9 into a format 4/3, the horizontal zoom factors of the pixels situated in a central zone of the image are thus close to 1 and the horizontal zoom factors of the pixels situated near the edges of the image are higher. The image is thus not too much deformed and there is not too much loss of information. It is possible to benefit from these variable zoom factors for correcting a trapezium distortion. In the example of FIG. 6, the horizontal zoom factor zH is progressively reduced from the top to the bottom of the screen 20. It should be noted that these variations of the horizontal zoom factor zH may be defined in a program. In practice, pressing on one of the keys of the remote control unit 12 or of the control interface 113 generates a control signal with which this program is executed. Whenever this key is pressed, the zoom factors of the pixels situated in the lower part of the screen 20 are thus incremented by relatively small quantities, while the zoom factors of the pixels situated in the upper part of the screen 20 are incremented by higher quantities. The user presses this key several times until a desired shape of the image 21 is obtained.

FIG. 7 illustrates a correction of a pin-cushion distortion. The image 21 has the shape of a pin-cushion which is due to a flatness fault of the screen 20. The variable zoom factors allow correction of this pin-cushion distortion. From the bottom to the top of the screen 20, the horizontal zoom factor is progressively increased until the middle of the screen 20 and then progressively reduced. From the left to the right of the screen 20, the horizontal zoom factor is progressively increased until the middle of the screen 20 and then progressively reduced. These variations of the variable horizontal and vertical zoom factors may also be defined in a program. As has been described with reference to FIG. 6, pressing on one of the keys of the remote control unit 12 or of the control interface 113 generates a control signal with which this program is executed. Whenever this key is pressed, the zoom factors of the pixels situated near the corners of the screen 20 are thus incremented by relatively small quantities, while the zoom factors of the pixels situated in the middle zones of the screen 20 are incremented by higher quantities. The user presses this key several times until a desired shape of the image 21 is obtained.

The description above with reference to the Figures illustrates rather than limits the invention. In this respect, several remarks are made below.

The description of the Figures refers to the example of the digital circuit HDVO. The invention is applicable to other digital circuits responsible for conversion of image formats. The names of the spatial digital factors may vary from circuit to circuit, but these factors may be used without departing from the scope of the invention when they fulfil similar functions.

An example of format conversion by the digital circuit 112 is described with reference to FIG. 2. It should be noted that other conversions may be envisaged without departing from the scope of the invention. For example, for computing the value of a pixel of the output image, a different number of input pixels may be taken into account, for example, three, four or more.

Examples of correcting geometrical faults of a cathode ray tube have been described in detail with reference to FIGS. 3 to 7. It should be noted that the invention is not limited to these faults only. For example, a correction of parallelism faults may also be performed by the correction device according to the invention.

1. A device for correcting geometrical faults of a cathode ray tube intended to display at least one output image, said device being characterized in that it comprises:
a digital spatial processing circuit suitable for converting an input signal representing an input image in a first format into an output signal representing the output image in a second format by means of predetermined spatial digital factors, and
means for adjusting said spatial digital factors, said adjusting means being controlled by control signals.

2. A correction device as claimed in claim 1, characterized in that said control signals are generated by a user by means of a control interface.

3. A correction device as claimed in claim 1, characterized in that said control signals are a function of characteristics of the image to be displayed.

4. A television set top box, characterized in that it comprises a device for correcting geometrical faults as claimed in claim 1.

5. A television set top box as claimed in claim 4, characterized in that said control signals are generated by a user by means of a control interface.

6. A television set top box as claimed in claim 4, characterized in that said control signals are a function of characteristics of the image to be displayed.

7. A television receiver comprising at least a cathode ray tube intended to display at least one output image and a device for correcting geometrical faults as claimed in claim 1.

8. A television receiver as claimed in claim 7, characterized in that said control signals are generated by a user by means of a control interface.

9. A television receiver as claimed in claim 7, characterized in that said control signals are a function of characteristics of the image to be displayed.
